(19) United States
(12) Patent Application Publication
(10) Pub. No.: US 2026/0177000 A1
(43) Pub. Date: Jun. 25, 2026

(54) A GAS TURBINE SYSTEM WITH SUPERSONIC CARBON DIOXIDE SEPARATOR AND METHOD

(71) Applicant: NUOVO PIGNONE TECNOLOGIE -S.R.L., Florence (IT)

(72) Inventors: Marco LISTORTI, Florence (IT); Gianni IANNUZZI, Florence (IT)

(21) Appl. No.: 19/125,170

(22) PCT Filed: Oct. 23, 2023
(86) PCT No.: PCT/EP2023/025442

§ 371 Date: Apr. 28, 2025

(30) Foreign Application Priority Data
Oct. 28, 2022 (IT) 102022000022254

(51) Int. Cl. F02C 3/04; B01D 53/14

(52) U.S. Cl. CPC F02C 3/04; B01D 53/1475

(57) ABSTRACT

The gas turbine system comprises a gas turbine engine and a flue gas discharge line fluidly coupled to the discharge side of the gas turbine engine an adapted to deliver flue gas to a flue gas compressor. The delivery side of the flue gas compressor is fluidly coupled to an expansion device, where the compressed flue gas is expanded causing a change of phase of the carbon dioxide from gaseous to liquid and/or solid. The liquid or solid carbon dioxide particles are removed from the flue gas prior to discharging the latter in the atmosphere. At least a partial carbon dioxide capture is thus obtained. To improve the efficiency of the system, a recycling line is further provided, connecting the flue gas discharge line to the suction side and adapted to recycle a portion of exhausted flue gas to the suction side of the gas turbine engine.

### TECHNICAL FIELD

The present disclosure concerns improvements to gas turbine engine systems comprising carbon dioxide capturing devices, and relevant methods.

### BACKGROUND ART

Power generation still heavily relies upon fossil fuels, such as natural gas, oil and the like. A mixture of air and fuel in liquid or gaseous form is ignited in the combustor of the gas turbine engine and the resulting hot and pressurized combustion gas, containing carbon dioxide, is expanded in the turbine to generate mechanical power, which is in part used to drive the air compressor of the gas turbine engine and partly made available on the output shaft of the turbine to drive a load, such as a compressor or the like (so-called “mechanical drive applications”) or an electric generator to convert the mechanical power into electric power (so-called “power generation applications”).

Carbon dioxide is a greenhouse gas having a negative environmental impact and is responsible for climate changes. Efforts have been made to remove carbon dioxide from expanded combustion gas, i.e. flue gas, or at least reduce the content thereof, prior to discharging the flue gas in the environment. Several complex carbon capture systems are currently under investigation.

A simple way of capturing carbon dioxide from exhaust flue gas originated from fossil fuel combustion is to expand the flue gas in a supersonic expansion nozzle. The sudden temperature drop in the supersonic expansion nozzle causes carbon dioxide to liquefy or solidify. The solid or liquid carbon dioxide particles can be separated from the gaseous flue gas flow, that is then discharged in the environment (see Morten Hammer et al: “CO₂ capture from off-shore gas turbines using supersonic gas separation”, in Energy Procedia 63 (2014) 243-252; doi: 10.1016/j.egypro.2014.11.026, available online at www.sciencedirect.com).

Currently known supersonic separation systems for carbon dioxide capture are not fully satisfactory and are energy demanding. Power required to run the carbon capture system reduces the overall energy efficiency of the system, thus reducing the advantage of carbon capture.

Improvements in systems using gas turbine engines and supersonic separation for carbon capture would therefore be welcomed in the art.

### SUMMARY

Disclosed herein is a gas turbine system, which comprises a gas turbine engine and a flue gas discharge line fluidly coupled to the discharge side of the gas turbine engine an adapted to deliver flue gas to a flue gas compressor. The delivery side of the flue gas compressor is fluidly coupled to an expansion device, where the compressed flue gas is expanded causing a change of phase of the carbon dioxide from gaseous to liquid and/or solid. Liquid or solid carbon dioxide particles separating from the expanding flue gas flow are removed from the flue gas prior to discharging the latter in the atmosphere. At least a partial carbon dioxide capture is thus obtained. To improve the efficiency of the system, a recycling line is further provided, connecting the flue gas discharge line to the suction side and adapted to recycle a portion of exhausted flue gas to the suction side of the gas turbine engine.

More specifically, according to one aspect, disclosed herein is a gas turbine system comprising a gas turbine engine and a flue gas discharge line which fluidly connects the gas turbine engine to an expansion device. The expansion device is adapted to expand the flue gas and thereby separate carbon dioxide from the flue gas flowing through the expansion device. The system further comprises a flue gas compressor along the flue gas discharge line upstream of the expansion device, to booster the pressure of the flue gas discharged by the gas turbine engine to a pressure adapted to subsequently expand the flue gas in the expansion device and cause carbon dioxide separation therefrom. The carbon dioxide separates from the flue gas in the expansion device following a change of phase from gaseous carbon dioxide to liquid o solid carbon dioxide.

A carbon dioxide collecting line fluidly coupled to the expansion device is adapted to collect carbon dioxide separated from the flue gas in the expansion device. The flue gas discharged in the atmosphere after carbon dioxide separation is therefore a CO2-lean flue gas, containing no carbon dioxide, or a reduced amount of carbon dioxide.

A recycling line connects the flue gas discharge line to the suction side of the gas turbine engine and is adapted to recycle a portion of exhausted flue gas to the suction side of the gas turbine engine. By recycling part of the flue gas, the percentage of carbon dioxide in the flue gas processed through the flue gas compressor and the expansion device is increased. More efficient carbon dioxide removal is achieved thereby. Compared to systems of the current art, wherein flue gas is not recycled, the configuration disclosed herein has (among others) the advantage that effective carbon dioxide capture and removal can be obtained with reduced dimension of the flue gas compressor and less energy required to drive the compressor. Moreover, the higher partial pressure of carbon dioxide in the flue gas expanded in the expansion device may be beneficial and result in a more efficient carbon dioxide solidification or lique-faction in the expansion device.

The expansion device can include an expander, such that power can be generated through expansion of the flue gas, while carbon dioxide is separated from the flue gas flow through expansion. The expansion device is combined with a heating device adapted to heat the expansion device, to at least partly prevent solidified carbon dioxide from sticking to the inner surface of the supersonic expansion device.

In preferred embodiments, the expansion device comprises a supersonic expansion nozzle rather than an expander. No power will be recovered from the expansion of the flue gas, but the supersonic expansion nozzle is less prone to wear caused by particles of solidified carbon dioxide.

Further features and embodiments of the gas turbine system according to the present disclosure are described below with reference to the attached drawings and are set forth in the appended claims.

According to a further aspect, a method for generating power from a hydro-carbon-containing fuel and capturing carbon dioxide from flue gas is disclosed herein. The method comprises the following steps:
generating mechanical power with a gas turbine engine having a suction side and a discharge side;
discharging flue gas from the gas turbine engine in a flue gas discharge line fluidly coupled to the discharge side of the gas turbine engine;
recycling a first portion of the discharged flue gas from the flue gas discharge line towards the suction side of the gas turbine engine;
compressing a second portion of the discharged flue gas in a flue gas compressor;
expanding the compressed flue gas portion in an expansion device along the flue gas discharge line and separating carbon dioxide from the flue gas flowing through the expansion device;
heating the expansion device, thus preventing solidified carbon dioxide from sticking to the inner surface of the expansion device.

According to some embodiments expansion device comprises an expander or, preferably, a supersonic expansion nozzle.

Further features and embodiments of the method according to the present disclosure are described below with reference to the attached drawings and are set forth in the appended claims.

### BRIEF DESCRIPTION OF THE DRAWINGS

Reference is now made briefly to the accompanying drawings, in which:

FIG. 1 shows a schematic diagram of a gas turbine system of the present disclosure in one embodiment;

FIG. 2 shows a schematic diagram of a gas turbine system of the present disclosure in a further embodiment;

FIG. 3 shows a schematic diagram of a gas turbine system of the present disclosure in a further embodiment;

FIG. 4 shows a schematic diagram of a gas turbine system of the present disclosure in a yet further embodiment; and

FIG. 5 shows a schematic diagram of a gas turbine system of the present disclosure, wherein the expansion device includes an expander.

### DETAILED DESCRIPTION

In short, a gas turbine engine system according to the present disclosure includes a flue gas discharge line which collects exhausted flue gas from the power turbine. The flue gas is compressed in a flue gas compressor and expanded in an expansion device, such as a supersonic expansion nozzle or a flue gas expander, to separate at least part of the carbon dioxide contained therein. Improved efficiency is achieved by adding a recycling line, wherethrough a portion of the flue gas is recycled towards the suction side of the gas turbine engine, prior to re-compression in the flue gas compressor. The percentage amount of carbon dioxide in the combustion gas is increased and carbon dioxide separation in the supersonic expansion nozzle is thus improved.

Several improvements of the basic system summarized above are described in more detail below, along with the relevant advantages achieved thereby.

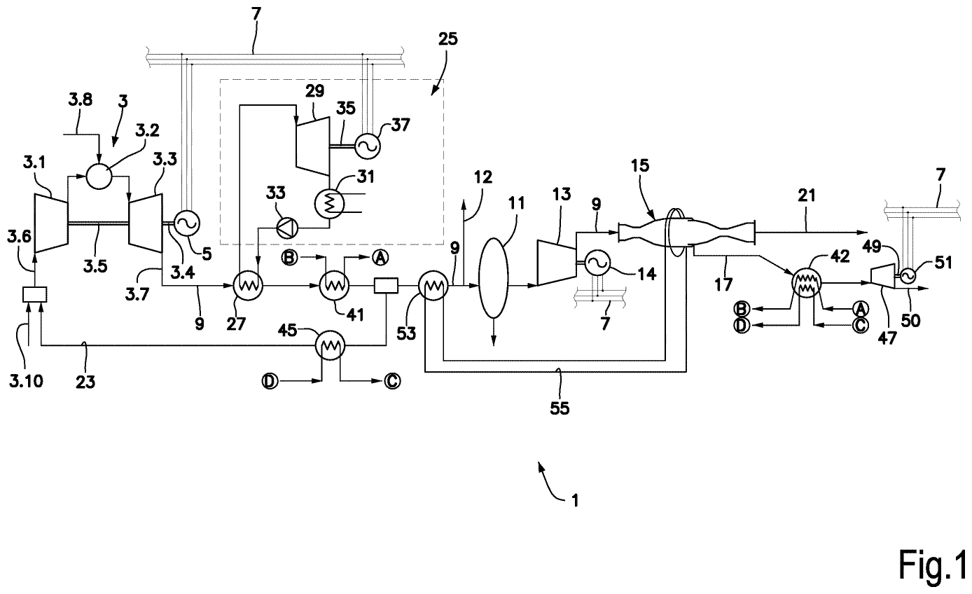

FIG. 1 illustrates a first schematic diagram of a gas turbine engine system 1 according to the present disclosure. The gas turbine engine system 1 comprises a gas turbine engine 3, which is represented only schematically in FIG. 1.

In the diagram of FIG. 1 the gas turbine engine 3 includes an air compressor section 3.1, a combustor 3.2 and a turbine section 3.3. The turbine section 3.3 is drivingly coupled to a turbine output shaft 3.4, on which useful power generated by the gas turbine engine 3 is available. The output shaft 3.4 can be drivingly coupled to an electric generator or to any other load, such as a gas compressor, for instance In FIG. 1 the output shaft 3.4 is drivingly coupled to an electric generator 5. The latter is in turn electrically coupled to an electric power distribution grid 7, for instance. A shaft 3.5 drivingly couples the turbine section 3.3 to the air compressor section 3.1. Reference number 3.6 indicates a suction side of the gas turbine engine 3 and reference number 3.7 indicates a delivery side of the gas turbine engine 3.

Even though in FIG. 1 the gas turbine engine is schematically represented as a one-shaft gas turbine engine, in other embodiments the gas turbine engine 3 can include any kind of gas turbine, e.g. an aeroderivative gas turbine or a heavy duty gas turbine with a variable number of shafts, air compressors and turbine wheels in combination.

Compressed air, or more specifically a mixture of compressed air and re-cy-cled flue gas as will be described in more detail below, is delivered from the air compressor 3.1 to the combustor 3.2 and fuel is added (fuel line 3.8) and mixed to the compressed air stream. The mixture is ignited and hot, pressurized combustion gas is delivered from the combustor 3.2 to the turbine section 3.3, where the combustion gas expands and cools. The gas enthalpy drop is converted into mechanical power partly used to drive the air compressor section 3.1 through shaft 3.5 and partly made available on the output shaft 3.4.

The discharge side 3.7 of the gas turbine engine 3 is fluidly coupled to a flue gas discharge line 9, along which a water removal unit 11 can be provided, to remove water from the flue gas. The water removal unit 11 may include one or more devices, such as a liquid/gas separator, a molecular sieve and the like.

In some embodiments, a discharge duct 12 can be provided along the discharge line 9, for instance upstream of the water separator 11, to discharge a fraction of the flue gas directly in the atmosphere, if so required.

Downstream of the water removal unit 11 a flue gas compressor 13 is arranged, wherein the dehydrated flue gas is compressed for subsequent expansion in an expansion device. In this embodiment, the expansion device includes a supersonic expansion nozzle (such as a Laval nozzle), schematically shown at 15. The flue gas compressor 13 can be driven by a driver, such as an electric motor 14, which can be electrically coupled to the electric power distribution grid 7.

The supersonic expansion nozzle 15 features a supersonic gas separator, in which the flue gas is expanded and abruptly chilled, such that carbon dioxide contained therein liquefies and/or solidifies.

The supersonic expansion nozzle 15 can be configured as described by Hammer et alii in the article mentioned in the introductory part of the present disclosure. A swirler can be provided in the supersonic expansion nozzle 15 or upstream thereof, to impart a tangential speed component to the flue gas, which facilitates the separation of condensing or solidifying carbon dioxide. The solid or liquid carbon dioxide particles collect at the periphery of the supersonic expansion nozzle 15 in the intermediate section thereof, and can be collected in a carbon dioxide collecting line 17. Usually, not the entire carbon dioxide contained in the flue gas is separated therefrom, but only a fraction thereof, while a fraction of carbon dioxide may remain in the flue gas released by the supersonic expansion nozzle 15 to the environment. A CO₂-rich stream is thus collected at the carbon dioxide collecting line 17, while a CO₂-lean flue gas is discharged at 21 from the supersonic expansion nozzle 15 in the atmosphere. In the present disclosure the term “CO₂-rich flue gas” indicates a flue gas containing a percentage amount of carbon dioxide higher than a “CO₂-lean flue gas”. Specifically, the CO₂-rich flue gas can be the flue gas entering the CO₂ supersonic expansion nozzle, i.e., the flue gas before CO₂ removal, while the CO₂-lean flue gas is the flue gas exiting the supersonic expansion nozzle, once at least a portion of CO₂ has been removed therefrom.

By way of non-limiting example, a CO₂-rich flue gas can contain from 5% wt to 15% wt of CO₂, and preferably 8% and 13% wt of CO₂, while a CO₂-lean flue gas may can contain from 0% wt to 2.5% wt of CO₂.

In the embodiment of FIG. 1 part of the flue gas discharged from the gas turbine engine 3 is recycled from the flue gas discharge line 9 back to the suction side 3.6 of the gas turbine engine 3, where the recycled flue gas is mixed with fresh air entering the air compressor 3.1 at 3.10. A recycling line 23 branches off from the flue gas discharge line 9 and returns a portion of recycled flue gas to the suction side 3.6 of the gas turbine engine 3.

Recycling a portion of the flue gas prior to compression of the flue gas in the flue gas compressor 13 reduces the flowrate of flue gas to be compressed and increases the percentage of carbon dioxide contained in the flue gas, which is finally compressed in the flue gas compressor 13 and expanded in the supersonic expansion nozzle 15. The efficiency of carbon dioxide separation by supersonic expansion is thus improved and the power required for carbon dioxide separation, namely the power needed to run the flue gas compressor 13, is reduced.

The flue gas discharged at the discharge side 3.7 of the gas turbine engine 3 contains waste heat at a relatively high temperature, e.g. in the range of 700° C. To further improve carbon dioxide separation and capture, the flue gas expanded in the supersonic expansion nozzle 15 shall be at a lower temperature.

In some embodiments, as shown in the schematic of FIG. 1, at least part of the waste heat contained in the flue gas discharged by the gas turbine engine 3 is removed and can be used to power a bottom thermodynamic cycle schematically shown at 25. The bottom thermodynamic cycle 25 can include a steam Rankine cycle, an organic Rankine cycle, using an organic working fluid, such as cyclopentane, carbon dioxide, or any other thermodynamic cycle using a working fluid suitably selected based upon the operating conditions of the system, e.g. upon the temperature at which heat is re-jected from the flue gas and absorbed in the bottom thermodynamic cycle.

By way of example only, in connection with the diagram of FIG. 1, reference will be made to a steam Rankine cycle 25. The circuit of the bottom thermodynamic cycle 25 schematically includes a heat exchanger 27, having a hot side through which flue gas flows in heat exchange with a working fluid which flows through the cold side of the heat exchanger 27. Heat transferred from the flue gas to the working fluid of the bottom thermodynamic cycle heats and vaporizes the working fluid. The hot and va-porized working fluid, e.g. steam, expands in a turbine, e.g. a steam turbine, schematically shown at 29, condenses in a condenser 31 and is pumped towards the heat exchanger 27 by a pump 33.

A turbine shaft 35 of the steam turbine 29 can be drivingly coupled to a load, for instance an electric generator 37. This latter can be electrically coupled to the electric power distribution grid 7.

As noted above, the bottom thermodynamic cycle 25 can be a steam Rankine cycle, but this is not the only possible option. In some embodiments an organic Rankine cycle (ORC) is used, wherein the working fluid can undergo cyclic thermodynamic transformations with or without a change of phase. For instance, the bottom thermodynamic cycle can be a supercritical CO₂ organic Rankine cycle using supercritical carbon dioxide.

The heat exchange towards the bottom thermodynamic cycle reduces the temperature of the flue gas prior to compression in the flue gas compressor and provides for an improved overall energy efficiency of the system 1 in that part of the waste heat removed from the flue gas is converted into useful mechanical or electric power.

The flue gas exiting the heat exchanger 27 may still contain waste heat that can be removed for improving the carbon capture in the supersonic expansion nozzle 15.

In the embodiment of FIG. 1, a further heat exchanger 41 is included, which is fluidly coupled to the carbon dioxide collecting line 17. Carbon dioxide flowing in the carbon dioxide collecting line 17 is at a low temperature and can be in a liquid phase, solid phase or in a mixed liquid and solid phase. Heat can be removed from the flue gas in the heat exchanger 41 by heat exchange with carbon dioxide in the carbon dioxide collecting line 17. References A and B represent schematically a thermal coupling between the heat exchanger 41 and the carbon dioxide collecting line 17. Thermal coupling can be achieved by directly flowing the flue gas through a hot side of the heat exchanger 41 and the carbon dioxide through a cold side of the heat exchanger 41. In other embodiments, as schematically depicted in FIG. 1, an intermediate heat transfer fluid can be used to indirectly transfer heat from the heat exchanger 41 to carbon dioxide flowing through a heat exchanger 42. References A and B represent a heat-transfer fluid connection between the heat exchangers 41 and 42.

The heat exchanger 41 can be located upstream of the inlet end of the recycling line 23, as shown in the schematic of FIG. 1. In this way the whole flue gas flow is cooled in the heat exchangers 27 and 41 before splitting into a first flue gas flow delivered to the flue gas compressor 13 and the supersonic expansion nozzle 15 and a second flue gas flow recycled through the recycling line 23. In some embodiments, the heat exchanger 41 can be arranged downstream of the point where the recycling line 23 branches off from the flue gas discharge line 9. In this case a further heat exchanger will be located along the recycling line 23.

In the embodiment of FIG. 1, the heat exchanger 41 is arranged upstream of the inlet end of the recycling line 23, and a further heat exchanger 45 is nevertheless provided along the recycling line 23. In this arrangement, therefore, the portion of flue gas which is recycled towards the suction side of the gas turbine engine 3 can be cooled in the heat exchanger 27, in the heat exchanger 41, and additionally cooled in the heat exchanger 45. Providing separate heat exchangers 41 and 45 can improve the operating conditions of the system 1 in that an additional regulation possibility is provided, which allows balanced removal of waste heat from the full flue gas flow (in heat exchanger 41) and from the partial recycled flue gas flow (in heat exchanger 45).

Similar to heat exchanger 41, also the heat exchanger 45 can be thermally coupled to the carbon dioxide collecting line 17, for instance through an intermediate heat-transfer loop, whereof C and D are the connection points with the heat exchanger 42 (or an additional heat exchanger along the carbon dioxide collecting line 17) and the heat exchanger 45.

In other embodiments, a heat exchanger 45 can be provided, which includes a hot side through which the recycled flue gas flows, and a cold side, through which the collected carbon dioxide (or part thereof) flows in heat exchange with the recycled flue gas.

The carbon dioxide (or more generally the CO₂-rich flow) collected in the carbon dioxide collection line 17 can be stored in any known manner or used in an industrial process.

In the embodiment of FIG. 1, the carbon dioxide flowing through the carbon dioxide collection line 17 can be further expanded to generate additional useful mechanical and/or electric power. For that purpose, a carbon dioxide expander 47 is provided, having an inlet side fluidly coupled to the carbon dioxide collection line 17 and adapted to expand carbon dioxide to generate mechanical power, which is made available on an output shaft 49 of the carbon dioxide expander 47. The carbon dioxide expander includes a bladed rotor drivingly connected to the output shaft. The expanded carbon dioxide is discharged along a discharge line 50. An electric generator 51 can be drivingly coupled to the output shaft 49 of the carbon dioxide expander 47 to convert mechanical power into electric power, which is delivered to the electric power distribution grid 7, whereto the electric generator 51 is electrically connected. In other embodiments, the output shaft 49 can be drivingly coupled to a different load, for instance a pump or a compressor, or any other rotary driven machine.

In some embodiments, measures can be taken to prevent solidified carbon dioxide from sticking to the inner surface of the supersonic expansion nozzle 15. For instance, parts of the supersonic expansion nozzle 15 can be heated for that purpose.

In the embodiment of FIG. 1 waste heat from the flue gas is used to heat the supersonic expansion nozzle 15. To that effect, a heating device is provided, which is schematically represented in FIG. 1 as a heating coil surrounding the supersonic expansion nozzle 15. The heating device is thermally coupled to a heat exchanger 53 located along the flue gas discharge line 9, which removes heat from the flue gas and transfers heat to the supersonic expansion nozzle 15 through the heating device including the heating coil. Heat can be transferred from the heat exchanger 53 to the heating coil in heat exchange with the supersonic expansion nozzle through a circulation loop 55, in which a heat-transfer fluid circulates. The heat exchanger 53 can be in any suitable position along the flue gas discharge line, for instance between the heat exchanger 41 and the water removal unit 11, as shown in FIG. 1. In some embodiments a different source of heat can be provided to heat the supersonic expansion nozzle 15, such as an electric resistor or the like. In some embodiments, an auxiliary heat source can be used in combination with the circulation loop 55 and the heat exchanger 53 to provide a supersonic expansion nozzle heating function during transient phases, when insuffi-cient waste heat is available from the flue gas.

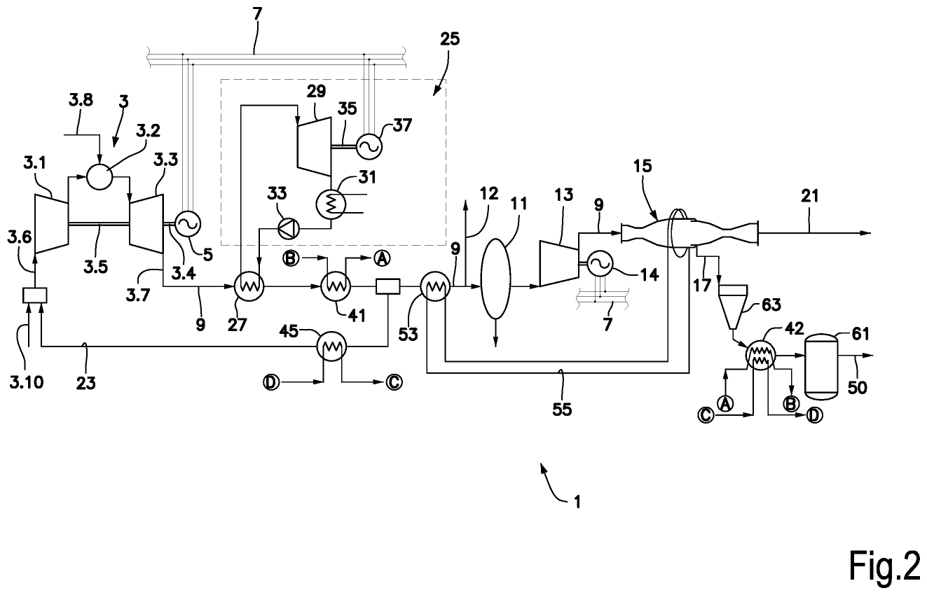

With continuing reference to FIG. 1, a further embodiment of a gas turbine engine system 1 according to the present disclosure is shown in FIG. 2. The same reference numbers designate the same components and parts as in FIG. 1 and described above. These parts will not be described again.

The main difference between the embodiment of FIG. 1 and the embodiment of FIG. 2 regards how the carbon dioxide collected at the supersonic expansion nozzle 15 is processed.

More specifically, in the embodiment of FIG. 2 a carbon dioxide collection vessel 61 is provided, which is adapted to collect liquefied or solidified carbon dioxide exiting the supersonic expansion nozzle 15.

In the embodiment of FIG. 2, a separator, for instance a cyclone separator 63, is added at the carbon dioxide discharge end of the supersonic expansion nozzle 15, to separate solid or liquid carbon dioxide particles from a gaseous component, i.e. mainly flue gas, which is moved through the supersonic expansion nozzle. A similar separator can be provided also in the embodiment of FIG. 1.

Carbon dioxide exiting the separator 63 is collected in the vessel 61, where the carbon dioxide can partly evaporate until reaching a settle-out pressure (SOP). The thus pressurized carbon dioxide can be processed further, e.g. transported or stored, or can be expanded fully or partly in a carbon dioxide expander, as shown in FIG. 1.

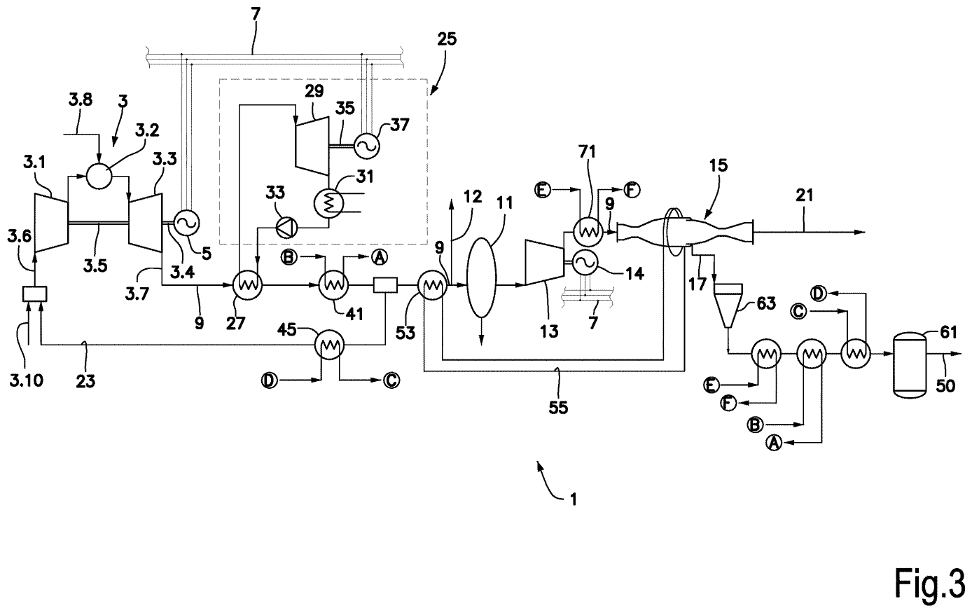

With continuing reference to FIGS. 1 and 2, a further embodiment of a gas turbine engine system 1 according to the present disclosure is shown in FIG. 3. The same reference numbers designate the same components and parts as in FIGS. 1 and 2 and described above. These parts will not be described again.

The main difference between the embodiments of FIGS. 1 and 2 and the embodiment of FIG. 3 is that a further heat exchanger 71 is arranged along the flue gas discharge line 9, between the delivery side of the flue gas compressor 13 and the supersonic expansion nozzle 15. While in FIG. 3 the additional heat exchanger 71 is shown in a system according to FIG. 2, the same additional heat exchanger 71 can be added in a system according to FIG. 1. The additional heat exchanger 71 is aimed at removing heat from the compressed flue gas before expansion, such that a lower temperature is achieved through the supersonic expansion nozzle and a more efficient carbon dioxide separation can be obtained. The heat exchanger 71 can be thermally coupled (see connections E, F) to the carbon dioxide collecting line 17, such that the compressed flue gas is cooled down prior to expansion by direct or indirect heat exchange with the carbon dioxide separated from the flue gas in the supersonic expansion nozzle 15.

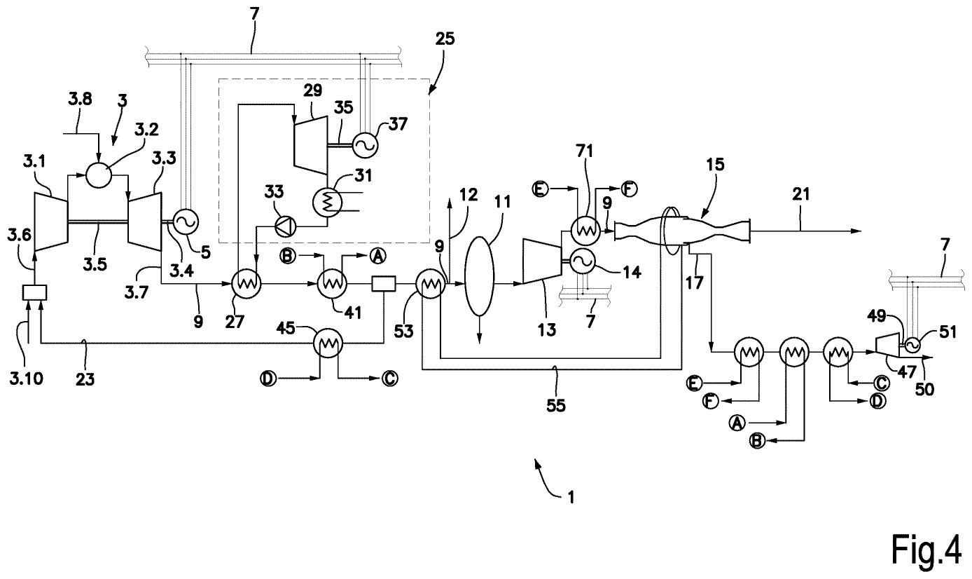

The same post-compression cooling of the flue gas can be provided in a system according to FIG. 1. This configuration is shown in FIG. 4, where the same parts already described in connection with FIGS. 1, 2 and 3 are labeled with the same reference numbers and are not described again.

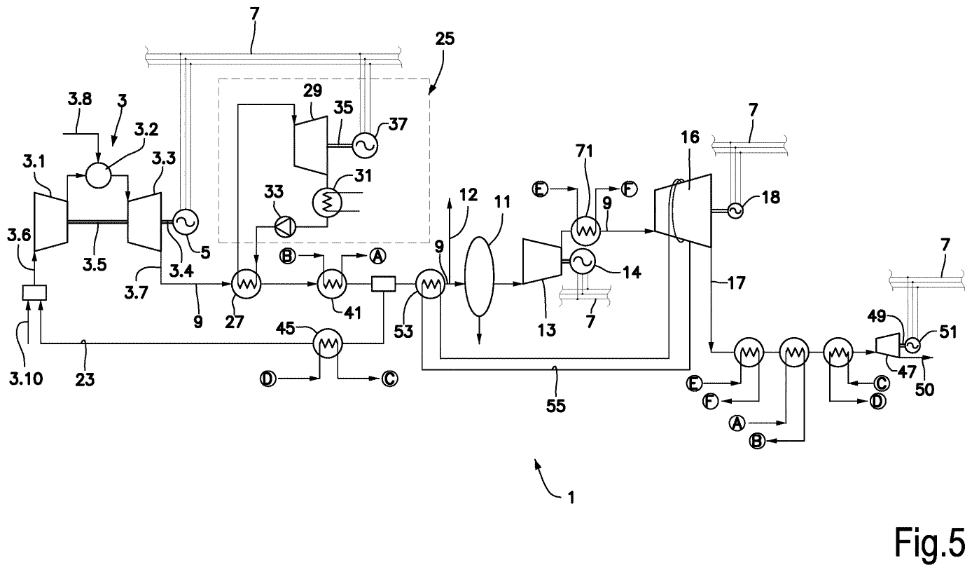

In the embodiments described so far, the compressed flue gas flow from the flue gas compressor 13 is expanded in a supersonic expansion nozzle 15. In other embodiments, however, expansion can be performed in an expansion device which includes a flue gas expander. The flue gas expander includes a bladed rotor which converts pressure energy of the flue gas int mechanical energy, to recover at least part of the power needed to compress the flue gas and convert said power into mechanical power available at the shaft of the expander rotor. The flue gas expander may include one or more impellers which are driven into rotation by the expanding flue gas. The flow parameters in the flue gas expander are such that at least part of the carbon dioxide contained in the expanding flue gas changes from a gaseous phase to a liquid or solid phase and can be removed. An embodiment using a flue gas expander instead of a static supersonic expansion nozzle is shown in FIG. 5. The embodiment of FIG. 5 differs from the embodiment of FIG. 4 only with respect to the kind of expansion device used. The flue gas expander is labeled 16. An electric generator 18 can be driven by the flue gas expander 16 to convert mechanical power generated by the expansion of the flue gas into electric power. The remaining components are the same as shown in FIG. 4 and labeled with the same reference numbers.

A flue gas expander can be used instead of a supersonic expansion nozzle also in the other embodiments shown in FIGS. 1 to 3.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A gas turbine system comprising:
a gas turbine engine with a suction side and a discharge side;
a flue gas discharge line fluidly coupled to the discharge side of the gas turbine engine; an expansion device along the flue gas discharge line, adapted to expand the flue gas and thereby separate carbon dioxide from the flue gas flowing through the expansion device;
a flue gas compressor along the flue gas discharge line upstream of the expansion device;
a carbon dioxide collecting line fluidly coupled to the expansion device and adapted to collect carbon dioxide separated from the flue gas in the expansion device;
a recycling line connecting the flue gas discharge line to the suction side and adapted to recycle a portion of exhausted flue gas to the suction side of the gas turbine engine and increase the overall percentage of carbon dioxide collected from the flue gas;
a heating device adapted to heat the expansion device.

2. The gas turbine system of claim 1, wherein the expansion device comprises a supersonic expansion nozzle.

3. The gas turbine system of claim 1, further comprising a first heat exchanger to remove heat from the flue gas upstream of the flue gas compressor.

4. The gas turbine system of claim 3, wherein the first heat exchanger is thermally coupled to a bottom thermodynamic cycle, and wherein the thermodynamic cycle is adapted to convert waste heat removed from the flue gas by the first heat exchanger into mechanical power.

5. The gas turbine system of claim 1, further comprising a second heat exchanger along the flue gas discharge line adapted to cool flue gas in heat exchange with carbon dioxide in the carbon dioxide collecting line.

6. The gas turbine system of claim 5, wherein the second heat exchanger is arranged downstream of the first heat exchanger with respect to a direction of flow of the flue gas in the flue gas discharge line.

7. The gas turbine system of claim 1, further comprising a third heat exchanger along the recycling line adapted to cool recycled flue gas in heat exchange with carbon dioxide in the carbon dioxide collecting line.

8. The gas turbine system of claim 1, wherein the heating device is in heat exchange relationship with the flue gas discharge line.

9. The gas turbine system of claim 8, wherein the heating device includes a fourth heat exchanger adapted to remove heat from the flue gas discharge line.

10. The gas turbine system of claim 1, further comprising a fifth heat exchanger along the flue gas discharge line between the flue gas compressor and the expansion device, the fifth heat exchanger being adapted to remove heat from compressed flue gas delivered by the flue gas compressor.

11. The gas turbine system of claim 10, wherein the fifth heat exchanger is in heat exchange with the carbon dioxide collecting line.

12. The gas turbine system of claim 1, further comprising a carbon dioxide expander to expand carbon dioxide from the expansion device and generate mechanical power therewith.

13. The gas turbine system of claim 1, comprising a carbon dioxide compression vessel, adapted to receive carbon dioxide from the expansion device and to compress the carbon dioxide by evaporation in the compression vessel up to a settle-out pressure (SOP).

14. A method for generating power from a hydrocarbon-containing fuel and capturing carbon dioxide from flue gas, the method comprising the following steps:
generating mechanical power with a gas turbine engine having a suction side and a discharge side;
discharging flue gas from the gas turbine engine in a flue gas discharge line fluidly coupled to the discharge side of the gas turbine engine;
recycling a first portion of the discharged flue gas from the flue gas discharge line towards the suction side of the gas turbine engine;
compressing a second portion of the discharged flue gas in a flue gas compressor;
expanding the compressed flue gas portion in an expansion device along the flue gas discharge line and separating carbon dioxide from the flue gas flowing through the expansion device heating the expansion device.

15. The method of claim 14, wherein the expansion device comprises a supersonic expansion nozzle.

16. The method of claim 14, further comprising the step of removing heat from the flue gas upstream of the flue gas compressor.

17. The method of claim 16, wherein the step of removing heat from the flue gas comprises the step of delivering waste heat from the flue gas to a bottom thermodynamic cycle; and
wherein the bottom thermodynamic cycle converts waste heat into mechanical power.

18. The method of claim 16, wherein the step of removing heat from the flue gas upstream of the flue gas compressor comprises the step of cooling the flue gas in heat exchange with carbon dioxide separated from the flue gas in the expansion device.

19. The method of claim 14, further comprising the step of cooling the recycled first portion of flue gas upstream of the suction side of the gas turbine engine.

20. The method of claim 19, wherein the step of cooling the recycled first portion of flue gas comprises the step of removing heat from the recycled flue gas by heat exchange with carbon dioxide separated from the flue gas in the expansion device.

21. The method of claim 14, wherein the step of heating the expansion device comprises the step of removing waste heat from the flue gas and delivering the removed waste heat to the expansion device.

22. The method of claim 14, further comprising the step of cooling the compressed flue gas downstream of the flue gas compressor.

23. The method of claim 22, wherein the step of cooling the compressed flue gas comprises the step of cooling the compressed flue gas in heat exchange with the carbon dioxide separated from the flue gas in the expansion device.

24. The method of claim 1, further comprising the step of expanding the carbon dioxide in a carbon dioxide expander and generating mechanical power therewith.
